(19) United States
(12) Patent Application Publication
(10) Pub. No.: US 2011/0303256 A1
(43) Pub. Date: Dec. 15, 2011

(54) PORTABLE SUNSHADE APPARATUS

(76) Inventor: ELAINE ASHLEY, PLEASANTAON, CA (US)

(21) Appl. No.: 12/814,409

(22) Filed: Jun. 11, 2010

(51) Int. Cl. E04H 15/58; H04N 5/64; G09F 19/00; G09F 23/00; F16B 2/20; G09F 7/00

(52) U.S. Cl. 135/117; 40/584; 224/600; 348/836; 348/E05.128

(57) ABSTRACT

A portable sunshade apparatus is disclosed for use with, for example, a recreational chair. In one embodiment, the sunshade apparatus has two side supports. Each side support has one or more of: an attachment provision, a vertical support leg, one or more radial support arms, a ratchet assembly connecting the radial arms to the vertical support leg, and a horizontally extending arm connected to an end of the radial support arms. A canopy element extends between the horizontally extending arms of each side support. The ratchet assembly and the attachment provision include features that allow the canopy to be adjusted in a variety of directions. In some instances, the canopy element is used for displaying promotional messages.

### FIELD OF INVENTION

The present invention generally relates to a portable sunshade apparatus. More particularly, the present invention relates to a portable sunshade apparatus that can be adjusted in a variety of directions to improve the overall shade cast by the portable sunshade apparatus.

### BACKGROUND OF THE INVENTION

Recreational chairs of various types, such as lawn chairs, patio chairs, lounge chairs, and the like, are well known. With the growing awareness of the harm caused by excessive sun exposure, there has been increased interest in developing sunshades for use with recreational chairs.

Large sunshade devices such as umbrellas or other canopies have been popularly used to provide shade for recreational chairs. However, large umbrellas are often too bulky and obtrusive for many uses. Additionally, many large sunshade devices are often bulky, making it difficult for portability to different places.

To remedy this, smaller canopy sunshade devices have been used. However, many of these smaller sunshades are usually permanently attached to the chair, making it difficult to easily use the canopy sunshade with different chairs. In addition, most of these sunshade devices cannot be quickly attached to and removed from the recreational chair. Many sunshades are required to be attached to rigid support members that provide little flexibility in adjusting the exact position of the canopy element relative to the recreational chair.

### SUMMARY OF THE DESCRIPTION

At least one embodiment of the present invention relates to a portable sunshade apparatus for use with, for example, a recreational chair. In one embodiment, the sunshade apparatus described herein includes a pair of attachment provisions, a pair of vertical support legs connected to the attachment provision, one or more support arms radially extending out from each vertical support leg, and a horizontally extending arm connecting to each set of radial support arms. A canopy element is allowed to stretch between the horizontally extending arms.

In one embodiment, the vertical support leg connects to the support arms by means of a ratchet assembly. This allows the support arms (and hence the canopy) to be adjusted in a forward or backward angle relative to the position of the vertical support legs. In one embodiment, the attachment provision (which allows the sunshade apparatus to be attached to, for example, the recreational chair) includes a ball-bearing assembly, allowing the vertical support legs to be moved in a variety of directions (e.g., forward/backward with respect to the recreational chair, sideward with respect to the recreational chair, swivel in situ, etc.). This adjustment feature allows a user to flexibly adjust the position of the canopy of the sunshade apparatus to enhance the efficacy of the sunshade apparatus.

In one embodiment, the support sides (i.e., each side comprising, for example, the support arms, the horizontally extending arm, the vertical support leg, the attachment provision, etc.) of the sunshade apparatus can be folded or collapsed in a longitudinal direction along the direction of the canopy, to allow the sunshade apparatus to be transported in a compact manner. By collapsing the sunshade apparatus to a compact size, a user would be able to, for example, easily store the sunshade apparatus in the trunk of a car, or carry it along in a shoulder bag.

In one embodiment, a user can use the canopy of the sunshade apparatus to display promotional messages. In some instances, the sunshade apparatus may include, for example, a wireless receiver, to receive the promotional messages as a digital signal. In such instances, the canopy uses a digital medium (e.g., an LCD screen) to display the received promotional message.

Other advantages and features will become apparent from the following description and claims. It should be understood that the description and specific examples are intended for purposes of illustration only and not intended to limit the scope of the present disclosure.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 illustrates an exemplary embodiment of a portable sunshade apparatus;

FIG. 2 depicts an example of an attachment provision that allows the sunshade apparatus to be attached to, for example, a surface of a recreational chair;

FIG. 3 depicts an example of a ratchet assembly of the sunshade apparatus;

FIGS. 4A and 4B depict functional features of the sunshade apparatus;

FIGS. 5A to 5D illustrate exemplary adjustments a user can make to the sunshade apparatus;

FIGS. 6A and 6B provide an exemplary illustration of a folding mechanism that allows the sunshade apparatus to be collapsed in a compact manner;

FIG. 7 illustrates a mechanism for including promotional messages on the canopy of the sunshade apparatus;

FIG. 8 depicts an example of a variation of the canopy element; and

FIGS. 9A and 9B provide examples of variations to the sunshade apparatus setup.

### DETAILED DESCRIPTION OF THE INVENTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

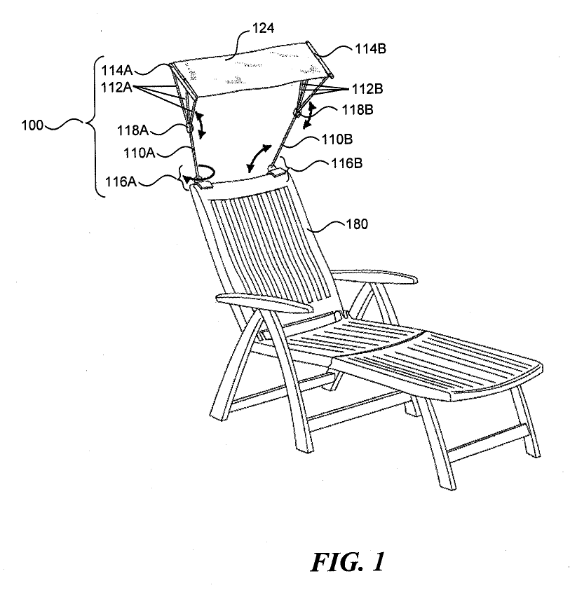

FIG. 1 illustrates an exemplary embodiment of a portable sunshade apparatus (or simply, the “sunshade apparatus”) 100. In FIG. 1, the sunshade apparatus 100 is attached to a recreational chair 180 (e.g., a lounge chair). It is noted that the recreational chair 180 is used for illustration purposes only. The sunshade apparatus 100 may be used in conjunction with (i.e., attached to) any other setup (e.g., stadium chairs, fence railings, support bars, etc.), as can be appreciated by a person of ordinary skill in the art.

In one embodiment, the sunshade apparatus includes a pair of vertical support legs (110A and 110B). Each vertical support leg (e.g., 110A) has a clipping mechanism (or any other attachment provision) (e.g., 116A) on one end and a ratchet assembly (e.g., 118A) on the other end. While the illustration in FIG. 1 shows a pair of vertical support legs (110A and 110B), a person of ordinary skill will appreciate that a single vertical support leg (not shown in FIG. 1) can be used, with extensions to the ratchet assembly pair (118A and 118B).

Returning to the illustration of FIG. 1, each ratchet assembly (e.g., 118A) of the sunshade apparatus 100 includes one or more support arms (e.g., 112A) extending outward (in a direction away from the direction of the vertical support leg 110A). In some instances, a plurality of support arms (e.g., 112A) are arranged in a radial fashion, where each support arm (extending from a given ratchet assembly 118A) radiates outward from the location of the ratchet assembly 118A. In some instances, the ratchet assembly 118A serves as the connector between the set of support arms 118A and the vertical support leg 110A. As will be discussed below, the pair of ratchet assemblies (118A and 118B) enable the support arms (112A and 112B) to be fixed at a desired angle in relation to the pair of vertical support legs (110A and 110B).

In one embodiment, each of the plurality of support arms (e.g., 112A) supports a horizontally extending arm (e.g., 114A). That is, the ends of the plurality of support arms 112A are attached to the horizontally extending arm 114A. In some instances, as illustrated in FIG. 1, the horizontally extending arm 114A is substantially orthogonal to the orientation to the support arms 112A. As will be discussed below, in at least some embodiments, the purpose of the horizontally extending arms (114A and 114B) is to provide support for the sunshade canopy element 124.

Each of the elements discussed above (i.e., the clamping mechanism 116A, the vertical support leg 110A, the ratchet assembly 118A, the support arms 112A, and the horizontally extending arm 114A) may be manufactured from metallic materials to provide sturdy support for clamping on to, for example, a recreational chair setup 180. However, other materials, such as plastic, wood, fiber glass, etc., as understood by a person of ordinary skill in the art, may be used for the manufacture of these elements.

Returning to FIG. 1, a canopy element 124 extends between the pair of horizontally extending arms (114A and 114B). In some instances, the canopy element 124 is a flat sheet of a flexible material (e.g., cloth based material, plastic material, paper based material, etc.) that provides shade over a region defined by the dimensions of the canopy element 124. It is understood that the length and width of the canopy material 124 can be increased or decreased to fit particular requirements, and that the dimensions of the remaining elements (e.g., the vertical support leg 110A, the horizontally extending arm 114A, etc.) would accordingly be adjusted in a proportional fashion.

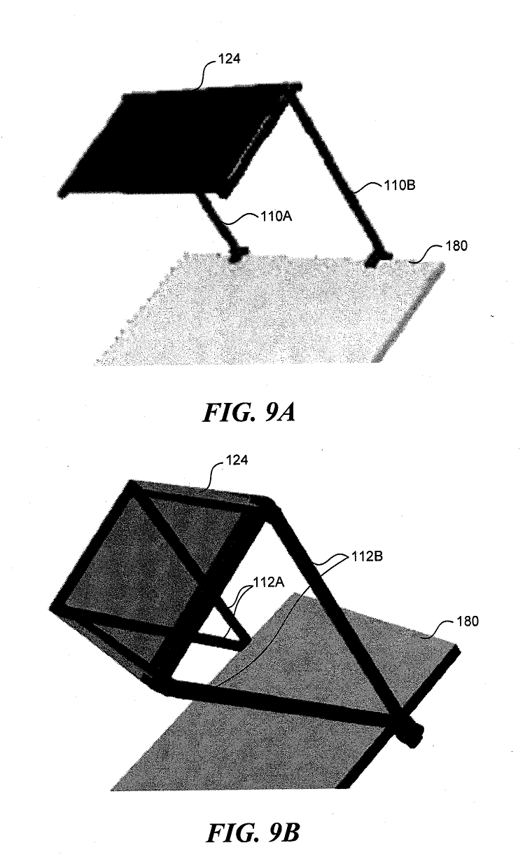

The description of FIG. 1 above discussed one exemplary embodiment of the sunshade apparatus 100. A person of ordinary skill in the art will appreciate that other embodiments, which include variations to the various elements described above, are within the purview of the invention disclosed in this application. For example, refer to FIGS. 9A and 9B, which provide examples of variations to the sunshade apparatus 100 setup. As shown in FIG. 9A, the vertical support legs directly connect to the canopy element 124 (or to the horizontally extending arms supporting the canopy element). The support arms (e.g., 112A of FIG. 1) are dispensed with in this example. The second example shown in FIG. 9B dispenses with the vertical support legs (e.g., 110A of FIG. 1). Instead, the support arms 112A and 112B directly connect the canopy element to the attachment provision 116A of the sunshade apparatus 100.

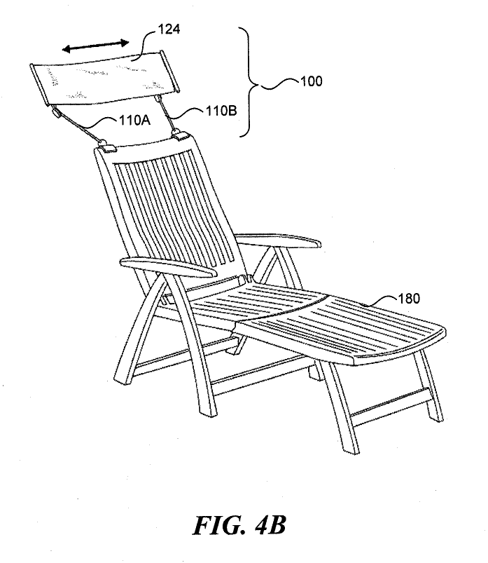

Now refer to FIGS. 4A and 4B, which depict functional features of the sunshade apparatus 100. In some instances, each vertical support leg (e.g., 110A) supports a sliding mechanism allowing the height of the vertical support leg 110A to be adjusted. For example, the vertical support leg 110A includes concentric two cylindrical elements, with a first cylindrical element sliding over the second cylindrical element. In this manner, the two cylinders can be extended out or collapsed within to adjust the overall length of the vertical support leg 110A to a desired value (i.e., as desired by a user using the sunshade apparatus 100).

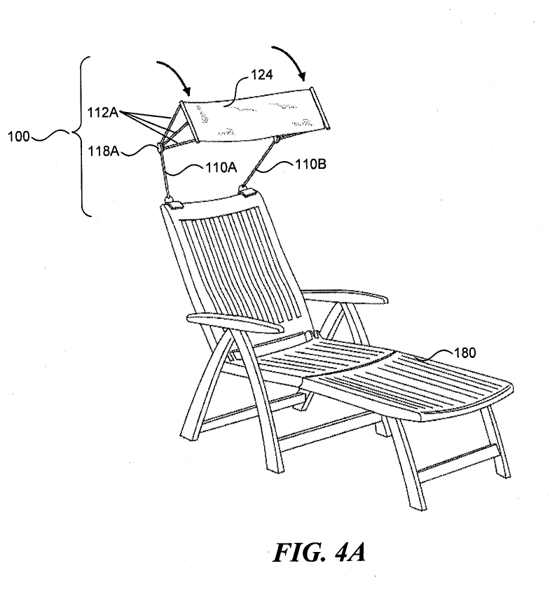

As illustrated in FIG. 4A, the ratchet assembly 118A serves as a junction between the vertical support leg 110A and the support arms 112A. In one embodiment, the ratchet assembly is a hinge type of assembly, which allows the pair of support arms (112A and 112B) to be moved in a forward or backward direction relative to the vertical support legs (110A and 110B). The ratchet hinge assembly 118A would allow the support arms 118A to be fixed at a particular angle (either in a forward or in a backward direction) relative to the vertical support leg 110A. An example of such a ratchet assembly is shown in detail in FIG. 3. By moving the support arms (118A and 118B) relative to the vertical support legs (110A and 110B), a user can adjust the position of the entire canopy 124 in a forward or backward direction. In this manner, a user can adjust the position of the canopy 124 to allow the sunshade apparatus 100 a cast a shade at a desired location.

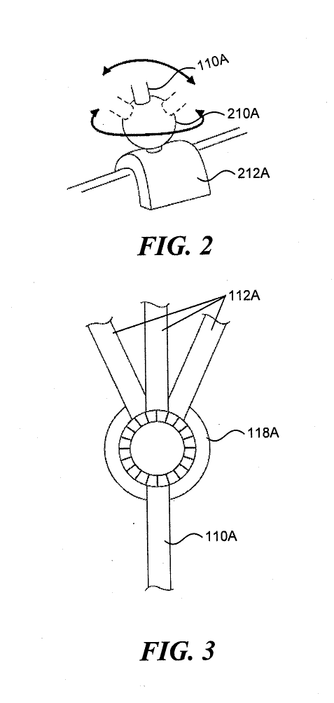

In one embodiment, as illustrated in FIG. 2, the attachment element (e.g., 116A) includes a combination of a ball-bearing assembly 210A and a clipping mechanism 212A. The clipping mechanism 212A allows the sunshade apparatus to be affixed (e.g., clamped or clipped on) to the surface of, for example, the lounge-chair 180. Of course, other mechanisms, as understood by a person of ordinary skill in the art, may be utilized to attach the sunshade apparatus 100 to the surface of the lounger chair 180. For example, a screw assembly may be used in the place of the clamping mechanism 212A to attach the sunshade to a surface of the lounge chair 180. Additionally, while the descriptions of FIGS. 4A and 4B show the attachment element (e.g., 116A) being attached to a top surface of the recreational chair 180, it is understood that the attachment element may be attached to any other surface (e.g., the sides of the recreational chair 180, the arm-bars of the recreational chair 180, etc.) as desired by the user of the sunshade apparatus 100.

The ball-bearing assembly 210A provides multiple functionalities. In one example, the ball bearing assembly 210A provides a junction support between the attachment mechanism 212A and the vertical support leg 110A. In one example, as illustrated in FIG. 4B, the ball bearing assembly 210A allows the vertical support legs (110A and 110B) to move in a sideward direction relative to the lounge chair 180. This feature further allows a user to adjust the position of the canopy (in a sideward manner) to ensure that the shade is cast in a desired location. Utilizing the forward-and-backward movement capability (afforded by the ratchet assembly 118A, as discussed with reference to FIG. 4A above), and the sideward movement capability (afforded by the ball-bearing assembly 210A), a user is provided a wide range of flexibility in fixing the canopy 124 (and hence the shadow cast by the canopy 124) at a desired location.

Additionally, in another example, the ball-bearing assembly 210A allows the vertical support leg 110A to be rotated (or swiveled) in situ. This swivel feature is illustrated in FIG. 2. This additional feature further enhances a user's range of flexibility in fixing the canopy 124 at a desired location.

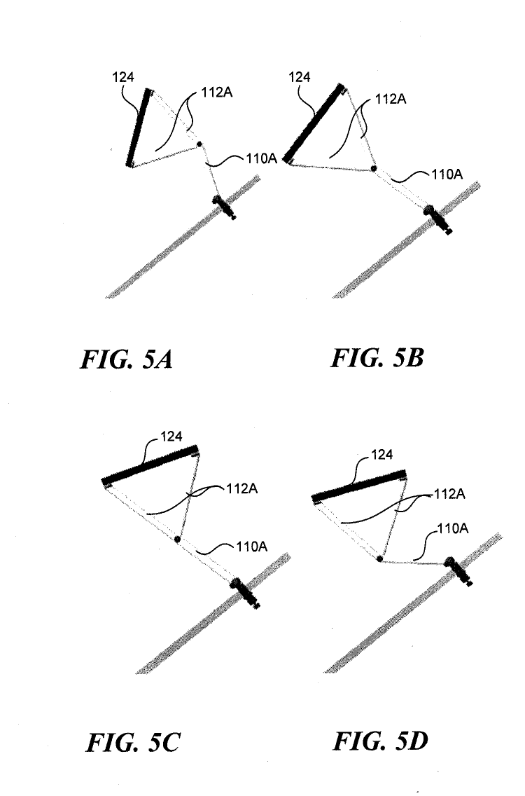

Refer now to FIGS. 5A to 5D, which illustrate exemplary adjustments a user can make to the sunshade apparatus 100. A user would be able to make each of these adjustments (as depicted in FIGS. 5A to 5D) using a combination of the ball-bearing assembly (e.g., 210A) and the ratchet assembly (e.g., 118A) adjustment features described above.

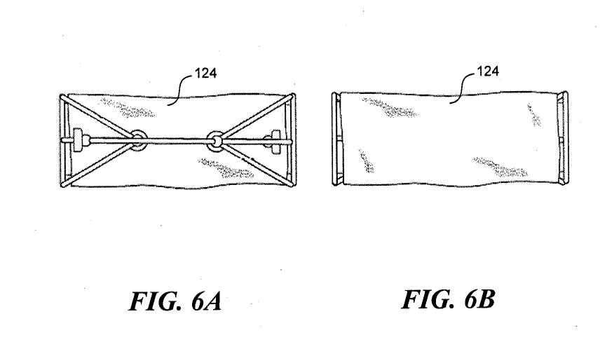

In one embodiment, the sunshade apparatus is built such that the support elements (i.e., the vertical support legs 110A and 110B, the support arms 112A and 112B, and the horizontally extending arms 114A and 114B) can be folded or collapsed to allow a user to easily transport the sunshade apparatus 100 in a compact manner. FIGS. 6A and 6B provide an exemplary illustration of such a folding mechanism. As shown in FIG. 6A, each support side of the sunshade apparatus 100 is folded longitudinally over the canopy 124. Other modes of folding (including folding each support side multiple times) by which the overall sunshade apparatus 100 can be collapsed in a compact manner, as understood by a person of ordinary skill in the art, may also be employed to achieve this result.

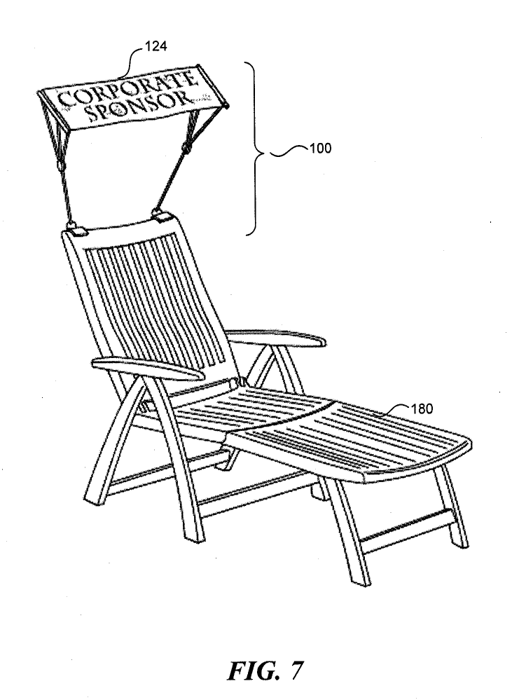

FIG. 7 illustrates a mechanism for including promotional messages on the canopy 124. In the example of FIG. 7, a promotional message is printed directly on the canopy 124. In other examples, the canopy 124 may include an attachment provision (e.g., a Velcro strap, a pushpin arrangement, a sleeve compartment, etc.) to allow a user to attach the promotional message to an existing canopy 124. By including this attachment provision, a user can cycle through multiple promotional messages (e.g., each printed on a distinct piece of paper or cloth material) over the same canopy 124.

In one embodiment, the canopy 124 may include a provision for displaying the promotional message using a digital medium (e.g., LED lights, LED screen, LCD screen, etc.). (Not shown in FIG. 7). The digital medium may be embedded on the surface of the canopy 124 or may be a separable attachment on the surface of the canopy 124. In one embodiment, the sunshade apparatus 100 may include a receiving device (e.g., a Bluetooth receiver) to receive a digital signal from a remote location. The digital display over the canopy 124 would then display the received digital signal as the promotional message.

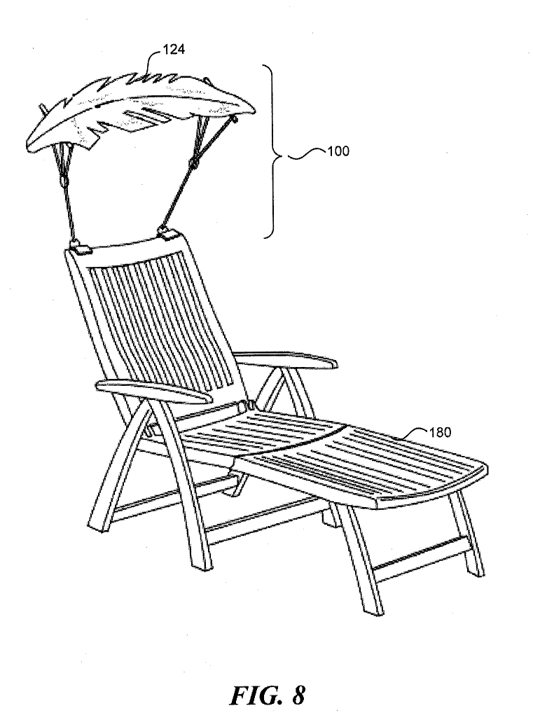

In some embodiments, the canopy may be designed in different shapes and sizes. One such example is depicted in FIG. 8, where the canopy 124 is shaped in the form of a banana leaf. In another example, the canopy 124 may include side flaps to improve the amount of shade that the sunshade apparatus 100 would be able to cast. Other examples of sizes and designs of the canopy 124, as understood by a person of ordinary skill in the art, are equally applicable for implementation in conjunction with the sunshade apparatus 100 described herein.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or subcombinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

We claim:

1. A portable sunshade apparatus for shading a chair, the portable sunshade apparatus comprising:
a pair of vertical support legs, each of the pair of vertical support legs having a top end and a bottom end;
a pair of attachment elements, each of the pair of attachment elements being attached to the bottom end of one of the pair of vertical support legs;
a pair of locking elements, each of the pair of locking elements being attached to the top end of one of the pair of vertical support legs;
a first plurality of support arms, each of the first plurality of support arms extending from a first locking element of the pair of locking elements;
a second plurality of support arms, each of the second plurality of support arms extending from a second locking element of the pair of locking elements;
a pair of horizontally extending arms, wherein a first arm of the pair of horizontally extending arms is connected to each of the first plurality of support arms, and a second arm of the pair of horizontally extending arms is connected to each of the second plurality of support arms; and
a canopy element extending between the pair of horizontally extending arms.

2. The portable sunshade apparatus of claim 1, wherein each of the pair of attachment elements includes a clipping mechanism adapted to enable the portable sunshade apparatus to be clipped on to a surface of the chair.

3. The portable sunshade apparatus of claim 2, wherein the clipping mechanism is adapted to enable the pair of vertical support legs of the portable sunshade apparatus to be clipped on to a top horizontal surface of the chair.

4. The portable sunshade apparatus of claim 1, wherein each of the pair of attachment elements includes a ball joint element, each ball joint element adapted to enable an associated vertical support leg to move in one or more directions, the one or more directions including:
a frontward direction;
a backward direction;
a sideward direction; or
a swivel direction.

5. The portable sunshade apparatus of claim 1, wherein each of the pair of vertical support legs includes a first vertical leg element and a second vertical leg element, wherein the first vertical leg element slides over the second vertical leg element enabling each of the pair of vertical support legs to be set at a desired length.

6. The portable sunshade apparatus of claim 1, wherein each of the pair of locking elements includes a ratchet hinge assembly, each ratchet hinge assembly adapted to enable an associated plurality of support arms to be locked at a specific angle relative to an associated vertical support leg.

7. The portable sunshade apparatus of claim 6, wherein each ratchet hinge assembly is adapted to enable the canopy element to be locked at a specific angle relative to the pair of vertical support legs.

8. The portable sunshade apparatus of claim 7, wherein each ratchet hinge assembly is adapted to offer a plurality of angle options at which the canopy element can be locked relative to the pair of vertical support legs.

9. The portable sunshade apparatus of claim 1, wherein each support arm of the first plurality of support arms extends radially from the first locking element, and wherein each support arm of the second plurality of support arms extends radially from the second locking element.

10. The portable sunshade apparatus of claim 1, wherein an exterior surface of the canopy element is adapted to display graphical information.

11. The portable sunshade apparatus of claim 10, wherein the graphical information is attached to the exterior surface of the canopy element using one or more of the following:
printing the graphical information on the exterior surface of the canopy element; or
attaching a prefabricated surface containing the graphical information on to the exterior surface using an adherence means.

12. The portable sunshade apparatus of claim 10, wherein the graphical information is displayed using a digital medium attached to the exterior surface of the canopy element.

13. The portable sunshade apparatus of claim 12, further including:
a receiver element configured to receive a digital signal from a remote entity, wherein the receiver element communicates the digital signal to the digital medium attached to the exterior surface of the canopy element.

14. The portable sunshade apparatus of claim 13, wherein the receiver element is a wireless-signal receiver.

15. The portable sunshade apparatus of claim 1, wherein the canopy element includes a vertical flap at least on one side.

16. The portable sunshade apparatus of claim 1, wherein the canopy element is adapted to be attached to the pair of horizontally extending arms using one or more fastening elements.

17. The portable sunshade apparatus of claim 1, wherein the portable sunshade apparatus is adapted to be folded by aligning each of the plurality of vertical support arms, the first plurality of support arms, and the second plurality of support arms in a direction substantially parallel to the canopy element.

18. The portable sunshade apparatus of claim 17, further including one or more of:
a sleeve adapted to accommodate a folded sunshade apparatus; or
carry-straps attached to a surface of the portable sunshade apparatus and or/to a surface of the sleeve;

19. The portable sunshade apparatus of claim 1, wherein the canopy element is adapted to be stretched to a desired length by moving each of the pair of vertical support legs in a direction away from each other.

20. A portable sunshade apparatus for shading a chair, the portable sunshade apparatus comprising:
a pair of vertical support legs, each of the pair of vertical support legs having a top end and a bottom end;
a pair of attachment elements, each of the pair of clipping elements being attached to the bottom end of one of the pair of vertical support legs, wherein the clipping elements enable the portable sunshade apparatus to be clipped on to a top vertical surface of the chair;
a pair of locking elements, each of the pair of locking elements being attached to the top end of one of the pair of vertical support legs;
a first plurality of support arms, each of the first plurality of support arms radially extending from a first locking element of the pair of locking elements;
a second plurality of support arms, each of the second plurality of support arms radially extending from a second locking element of the pair of locking elements;
a pair of horizontally extending arms, wherein a first arm of the pair of horizontally extending arms is connected to each of the first plurality of support arms, and a second arm of the pair of horizontally extending arms is connected to each of the second plurality of support arms; and
a canopy element extending between the pair of horizontally extending arms;
wherein, the first plurality of support arms and the second plurality of support arms are attached to respective top ends of the pair of vertical support legs using a ratchet hinge assembly, the ratchet hinge assembly enabling the canopy element to be adjusted to a specific angle relative to the pair of vertical support legs, and
wherein, each of the pair of vertical support legs is adapted to move in one or more directions with respect to one of the attachment elements, the one or more directions including a forward direction, a backward direction, a sideward direction, or a swivel direction.

21. The portable sunshade apparatus of claim 20, wherein the portable sunshade apparatus is adapted to be folded by aligning each of the plurality of vertical support arms, the first plurality of support arms, and the second plurality of support arms in a direction substantially parallel to the canopy element.

22. The portable sunshade apparatus of claim 21, further including one or more of:
a sleeve adapted to accommodate a folded sunshade apparatus; or
carry-straps attached to a surface of the portable sunshade apparatus and or/to a surface of the sleeve;

23. A portable sunshade apparatus for shading a chair, the portable sunshade apparatus comprising:
a pair of vertical support legs, each of the pair of vertical support legs having a top end and a bottom end;
a pair of attachment elements, each of the pair of clipping elements being attached to the bottom end of one of the pair of vertical support legs, wherein the clipping elements enable the portable sunshade apparatus to be clipped on to a top vertical surface of the chair;
a pair of locking elements, each of the pair of locking elements being attached to the top end of one of the pair of vertical support legs;
a first plurality of support arms, each of the first plurality of support arms radially extending from a first locking element of the pair of locking elements;
a second plurality of support arms, each of the second plurality of support arms radially extending from a second locking element of the pair of locking elements;
a pair of horizontally extending arms, wherein a first arm of the pair of horizontally extending arms is connected to each of the first plurality of support arms, and a second arm of the pair of horizontally extending arms is connected to each of the second plurality of support arms; and
a canopy element extending between the pair of horizontally extending arms,
wherein, the canopy element is adapted to display a graphical information on an upper surface and/or a lower surface of the canopy element, the graphical information being attached to the upper and/or lower surface of the canopy element by printing the graphical information or by attaching a prefabricated surface containing the graphical information using an adherence means.

24. A method for displaying promotional messages using a sunshade apparatus, the method comprising:
attaching a digital display medium to a canopy of a sunshade apparatus;
receiving, using an electronic receiving device connected to the sunshade apparatus, a digital signal, wherein the digital signal is indicative of a promotional message to be displayed using the digital display medium;
communicating the received digital signal to the digital display medium attached to the canopy; and
displaying the promotional message, derived from the digital signal, using the digital display medium attached to the canopy of the sunshade apparatus.

25. The method of claim 24, wherein the sunshade apparatus comprises:
a pair of vertical support legs, each of the pair of vertical support legs having a top end and a bottom end;
a pair of attachment elements, each of the pair of attachment elements being attached to the bottom end of one of the pair of vertical support legs;
a pair of locking elements, each of the pair of locking elements being attached to the top end of one of the pair of vertical support legs;
a first plurality of support arms, each of the first plurality of support arms extending from a first locking element of the pair of locking elements;
a second plurality of support arms, each of the second plurality of support arms extending from a second locking element of the pair of locking elements;
a pair of horizontally extending arms, wherein a first arm of the pair of horizontally extending arms is connected to each of the first plurality of support arms, and a second arm of the pair of horizontally extending arms is connected to each of the second plurality of support arms;
wherein the canopy element extends between the pair of horizontally extending arms.
